(19) United States
(12) Patent Application Publication
(10) Pub. No.: US 2026/0225224 A1
(43) Pub. Date: Aug. 6, 2026

(54) FLEXIBLE GRABBER TOOL

(71) Applicant: TR TOOLS, L.L.C., Orange City, IA (US)

(72) Inventors: Taylor James Deegan, Orange City, IA (US); James Hellinga, Orange City, IA (US)

(21) Appl. No.: 19/575,344

(22) Filed: Mar. 23, 2026

Related U.S. Application Data
(63) Continuation-in-part of application No. 29/957,271, filed on Aug. 13, 2024, now Pat. No. D1138613.

(51) Int. Cl. B25J 1/02

(52) U.S. Cl. CPC B25J 1/02

(57) ABSTRACT

An elongated tool is provided for picking up and holding objects in remote or small spaces. The tool includes an elongated flexible body with upper and lower ends defining a longitudinal axis. A clamp on the lower end of the body is movable between open and closed positions, and extends angularly from the longitudinal axis. An actuator on the upper end of the body manually controls opening and closing of the clamp so as to pick up and/or grip a variety of small objects.

### CROSS REFERENCE TO RELATED APPLICATIONS

This is a continuation-in-part patent application which claims priority under 35 U.S.C. § 120 to U.S. Serial No. 29/957,271, filed August 13, 2024, which is hereby incorporated by reference in its entirety, including without limitation, the specification, claims, and abstract, as well as any figures, or drawings thereof.

### TECHNICAL FIELD

The invention is directed toward a handheld tool for grabbing and picking up small objects from difficult to reach spaces.

### BACKGROUND

Handheld grabbing or gripping tools are well known for holding small objects. Some tools are elongated in use for picking up objects off the floor or in tight spaces. Other tools are flexible to reach areas that cannot be normally or easily reached by hand. All these tools typically have an elongated body, with jaws at the lower end and an actuator at the top end to open and close the jaws. The jaws are oriented coaxially with the axis of the body, and can only pick up an object that is aligned with the longitudinal axis of the body. These tools cannot be used when an object is offset or misaligned from the axis.

Therefore, a primary objective of the present invention is the provision of a flexible grabbing tool which can pick up and hold a small object without being centrally aligned with the axis of the tool body.

Another objective of the present invention is the provision of an extension gripping tool having jaws offset 90° from the axis of the tool body.

Another objective of the present invention is a provision of a handheld tool for grabbing small objects which can be held in one hand and actuated with the user's thumb of the same hand.

A further objective of the present invention is the provision of a tool which can be inserted into tight spaces to grip or hold an object where the user cannot physically reach with their own hand.

These and other objectives become apparent from the following description of the invention.

### SUMMARY

A tool allows a person to pick up and/or hold a small object in tight or remote spaces when the user cannot reach with their own hand. The tool includes an elongated body, with a clamp comprising a set of jaws at one end and an actuator at the other end. The clamp and jaws are oriented 90° relative to the longitudinal axis of the body. The actuator can be operated with one hand to open and close the clamp jaws so as to pick up and hold a small object. The body is flexible and can be straight or bent into various configurations to accommodate the space the user needs to reach. In a first embodiment, the actuator is a spring-biased push button which opens the jaws when depressed, and closes the jaws when retracted. In a second embodiment, the actuator is a threaded wheel which can be turned in a first direction to allow the jaws to slide open and threaded in an opposite direction to close the jaws for holding an object.

### BRIEF DESCRIPTION OF THE DRAWINGS

FIG. 1 is a perspective view of a first embodiment of the tool of the present invention, with the clamp jaws in a closed position.

FIG. 2 is a top plan view of the tool shown in FIG. 1.

FIG. 3 is a bottom plan view of the tool shown in FIG. 1.

FIG. 4 is a front side elevation view of the tool shown in FIG. 1.

FIG. 5 is a rear elevation view of the tool shown in FIG. 1.

FIG. 6 is a left side elevation view of the tool shown in FIG. 1.

FIG. 7 is a right side elevation view of the tool shown in FIG. 1.

FIGS. 8 and 9 are left and right side elevation views of an alternative embodiment wherein the actuator is in the form of a threaded wheel.

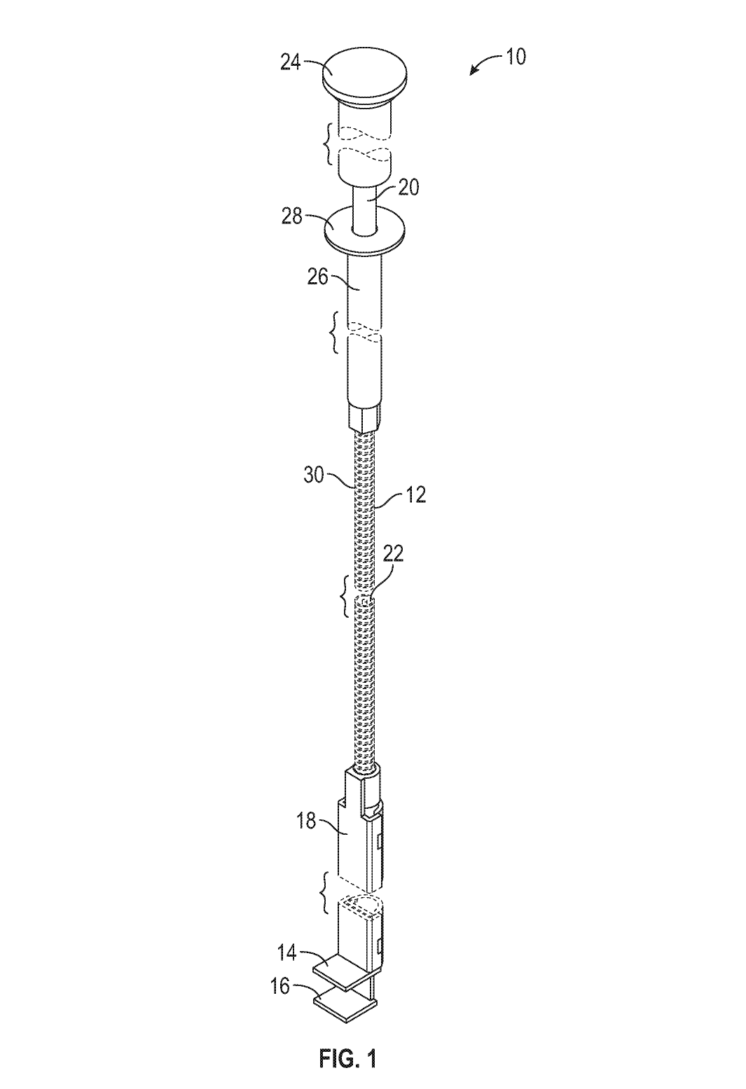

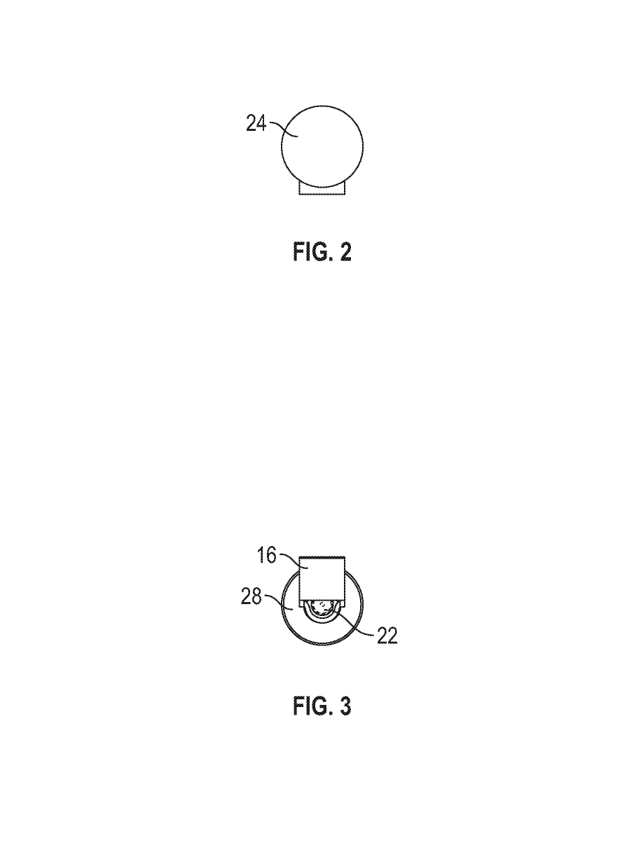

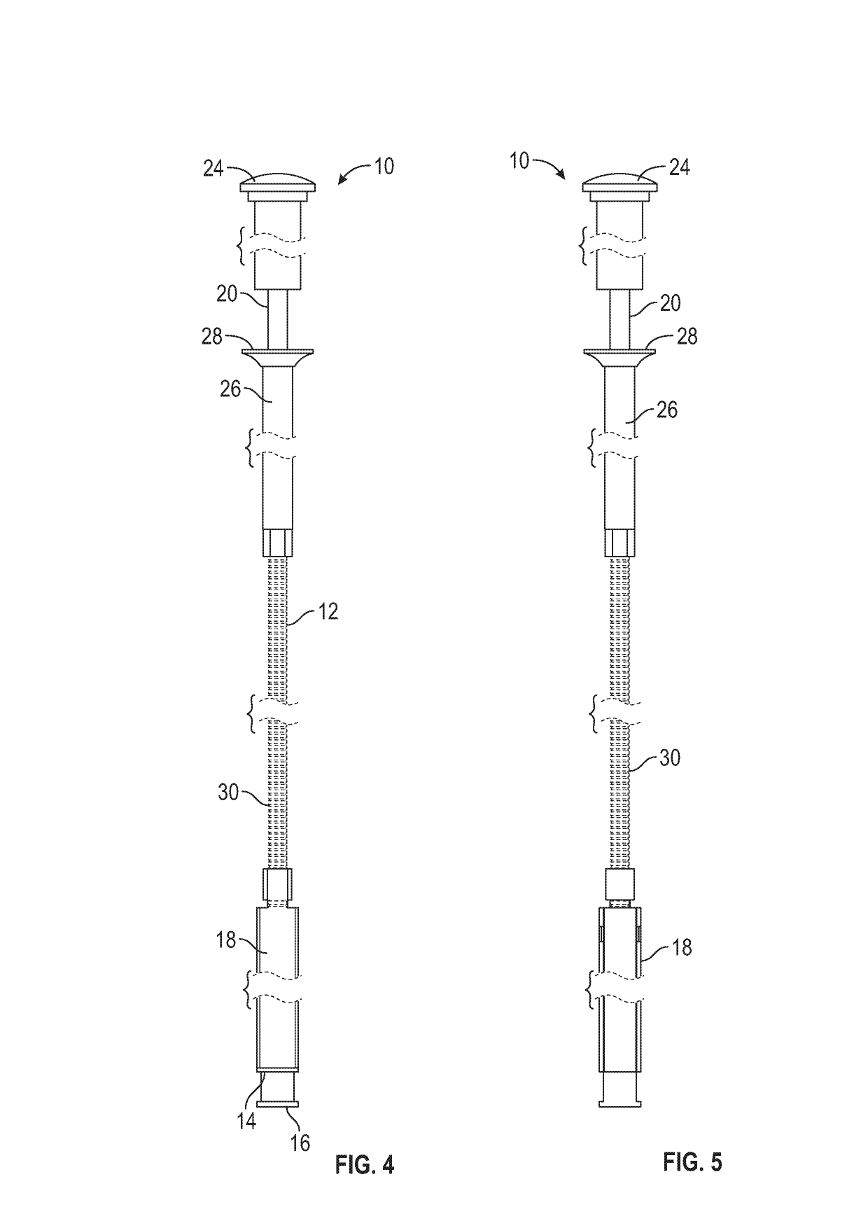

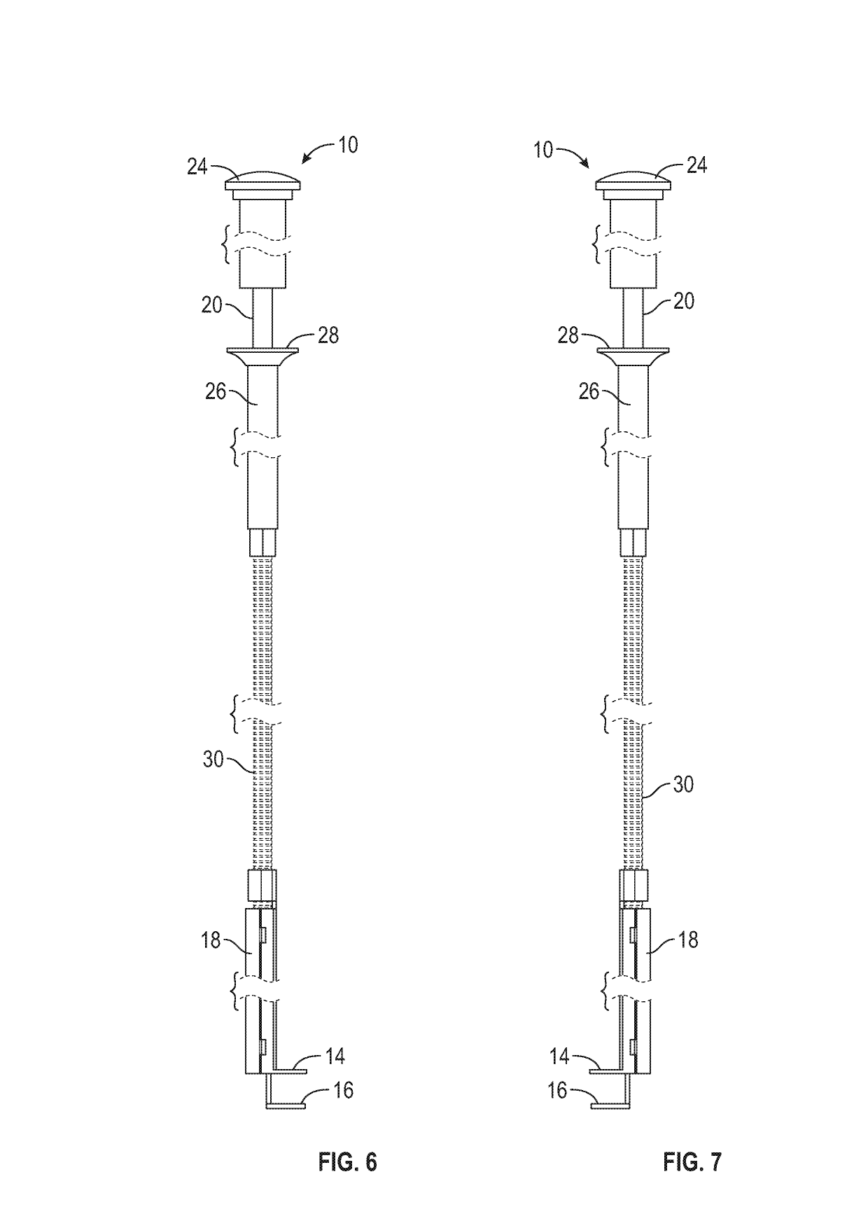

### DETAILED DESCRIPTION

A first embodiment of the grabber and gripping tool of the present invention is generally designated by the reference numeral 10 in the drawings. The tool includes an elongated body 12. Upper and lower jaws 14, 16 are operatively connected to the lower end of the body 12. The jaws 14, 16 define a clamp which can be opened and closed for gripping and holding a small object, such as a nut, a bolt, and other wide variety of items. A jaw housing 18 is provided at the lower end of the body 12. The upper jaw 14 is fixed to the housing 18, and the lower jaw 16 is slidably mounted in the housing 18.

A manual actuator 20 is connected to an upper end of the body 12. The actuator 20 includes a cable 22 extending through the body 12, and a knob 24 attached to the upper end of the cable 22. The lower end of the cable 22 is connected to the lower jaw 16. The actuator 20 includes a handgrip 26, with an upper flange 28. A spring (not shown) is provided in the housing or handgrip 26, as is known in prior art grabber tools. The spring biases the actuator knob 24 to a raised or extended position, thereby moving the lower jaw 16 to the closed position relative to the upper jaw 14.

The body 12 includes a flexible or coiled housing 30 surrounding the cable 22. The housing 30 can be bent or curved such that the tool 10 can reach a desired location or space, which the user cannot otherwise reach with their own hand. The housing 30 may be resilient or non-resilient. The non-resilient housing will hold a bent orientation as determined by the user, whereas a resilient housing 30 will return the body 12 to a straight alignment.

The body 12 has a longitudinal axis between the upper and lower ends. The clamp or jaws 14, 16 are oriented at an angle relative to the longitudinal axis of the body 12. This lateral or transverse offset displacement of the jaws relative to the tool body allows objects to be picked up and held without being axially aligned with the body 12. The drawings show the jaws 14, 16 at 90° to the longitudinal axis of the body 12, though other angles are within the scope of the invention. The configuration of the jaws 14, 16 is advantageous over prior art grabber tools when the jaws are axially aligned with the tool body and thus require the object to also be aligned with the tool body in order to be picked up and held. Also, the flat surfaces of the jaws 14, 16 provides enhanced gripping force on objects, such as a nut or bolt head, or other types of fasteners, by gripping the opposite flat sides of the nut or bolt head, or opposite sides of the fastener, which can be steadily held while threading an opposite nut or bolt onto the bolt or nut, or other threaded fastener, by hand or with a wrench. Conventional flexible jaws cannot grip a nut or bolt in a similar manner which tends to rotate due to insufficient gripping force. The tool 10 can be used in tight spaces, (such as engine compartments, behind automotive dashboards, inside wall cavities, and the like), which prior art claw tools cannot reach or function.

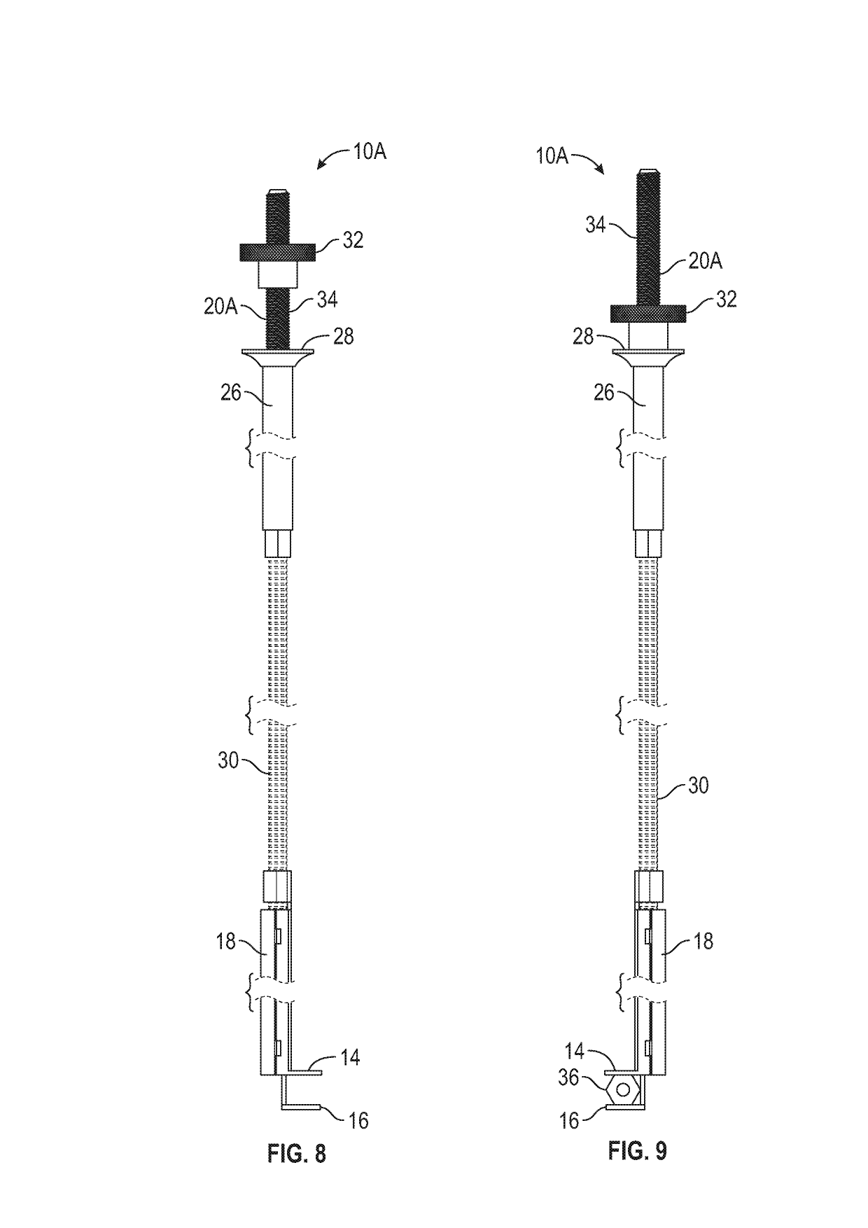

FIGS. 8 and 9 show a second embodiment of the grabbing and gripping tool 10A, which is identical to the first embodiment of the tool 10, except for the actuator. In the second embodiment of the tool 10A, the actuator 20A is a threaded wheel 32 to be turned in opposite directions on a threaded shaft 34. The shaft 34 is connected to the lower jaw 16. As shown in FIG. 8, when the wheel 32 is threaded in the first direction so as to be tightened against the flange 28, the lower jaw 16 is closed toward the upper jaw 14, so as to grip and hold an object, such as a nut, bolt, or other fastener 36. As shown in FIG. 9, when the wheel 32 is turned in the opposite direction so as to be spaced from the flange 28, the lower jaw 16 is extended or opened away from the upper jaw 14, in preparation for receiving the object.

FIG. 9 shows the fastener 36 held in a specific orientation between the jaws 14, 16. It is understood that the orientation of the fastener may vary, depending upon the type of fastener, and in the location where the tool 10 or 10A means to reach.

The “invention” is not intended to refer to any single embodiment of the particular invention but encompass all possible embodiments as described in the specification and the claims. The “scope” of the present disclosure is defined by the appended claims, along with the full scope of equivalents to which such claims are entitled. The scope of the disclosure is further qualified as including any possible modification to any of the aspects and/or embodiments disclosed herein which would result in other embodiments, combinations, subcombinations, or the like that would be obvious to those skilled in the art.

What is claimed is:

1. A tool to pick up objects, comprising:
an elongated flexible body having opposite first and second ends defining a longitudinal axis;
a clamp on the first end of the body movable between open and closed positions, and extending angularly from the longitudinal axis; and
an actuator on the second end of the body for manually moving the clamp to the open position.

2. The tool of claim 1 whereby the flexible body is movable between a straight position and a bent position.

3. The tool of claim 2 wherein the clamp is actuable with the flexible body in both the straight and bent positions.

4. The tool of claim 1 wherein the flexible body includes a flexible housing and a cable extending through the flexible housing.

5. The tool of claim 4 wherein the cable has opposite ends connected to the clamp and to the actuator.

6. The tool of claim 1 wherein the clamp has opposing first and second jaws.

7. The tool of claim 6 wherein the first jaw is stationary and the second jaw is movable by the actuator to grip an object between the jaws.

8. The tool of claim 6 wherein the second jaw is biased to a retracted position.

9. The tool of claim 1 wherein the actuator is a knob which manually pushes the clamp to the open position.

10. The tool of claim 1 wherein a threaded shaft is operatively connected to the clamp, and the actuator is a threaded wheel rotatable in opposite directions on the shaft to open and close the clamp.

11. The tool of claim 1 further comprising a hand grip portion between the flexible body and the actuator.

12. The tool of claim 1 wherein the clamp is oriented 90° to the longitudinal axis.

13. A tool to hold an object, comprising:
an elongated body having upper and lower ends;
a pair of jaws on the lower end of the body;
an actuator on the upper end of the body;
the actuator extending through the body and being connected to at least one of the jaws;
whereby when the actuator is moved in a first direction, the jaws open to receive the object, and when the actuator is moved in a second direction opposite the first direction, the jaws close to hold the object.

14. The tool of claim 13 wherein the body is flexible.

15. The tool of claim 13 wherein the jaws extend perpendicularly from the lower end of the body.

16. The tool of claim 13 wherein the actuator includes a cable, and the body includes a housing extending around the cable, whereby the cable and the housing are bendable.

17. The tool of claim 16 wherein the cable extends out of opposite ends of the housing.

18. The tool of claim 16 further comprising a hand grip on one end of the housing.

19. The tool of claim 18 wherein the actuator includes a knob on top of the hand grip.

20. The tool of claim 18 wherein the cable extends out of the hand grip.

21. The tool of claim 20 wherein the body is movable between straight and curved configurations.

22. The tool of claim 13 wherein one of the jaws is stationary and the other of the jaws is movable.

23. The tool of claim 13 further comprising a threaded shaft operatively connected to one of the jaws, and the actuator comprising a wheel threaded on the shaft to extend and retract the shaft and thereby open and close the jaws to hold the object.
